(19) United States
(12) Patent Application Publication
(10) Pub. No.: US 2012/0240194 A1
(43) Pub. Date: Sep. 20, 2012

(54) Systems and Methods for Controlling Access to Electronic Data

(75) Inventor: Jacques H. Nack Ngue, Pasadena, CA (US)

(73) Assignee: eClaris Software, Inc., South Pasadena, CA (US)

(21) Appl. No.: 13/167,564

(22) Filed: Jun. 23, 2011

Related U.S. Application Data
(60) Provisional application No. 61/454,405, filed on Mar. 18, 2011.

(51) Int. Cl. G06F 21/20; G06F 7/04

(52) U.S. Cl. 726/4; 726/28

(57) ABSTRACT

Access to an organization's electronic data is controlled by receiving login information for an individual, authenticating the individual based on the received login information, and granting permissions to the authenticated individual for a portion of an organization's electronic data. The granted permissions are associated with rote assignments for the individual, which role assignments are independent of any organizational structure, and may be granted to the individual for more than one role assignment based on the same authenticated login information. Further, an individual may be denied some role assignments to preclude access to certain portions of the organization's electronic data.

### PRIORITY CLAIM

This application claims priority to provisional Patent Application No. 61/454,405, filed Mar. 18, 2011, which is incorporated by reference in its entirety herein.

### BACKGROUND OF THE INVENTION

For an organization's electronic data to remain secure, the organization must limit the individuals who have permission to access each portion of the data. Organizations often use a role based model for controlling access. In a role based model, roles are defined for the various job functions in the organizational hierarchy and are assigned access rights, often referred to as “permissions,” to particular portions of the organization's electronic data. For example, a secretary role for a particular department may be assigned permissions to read and write to the set of electronic documents created by the individuals in the department. Once roles have been defined and assigned permissions, each individual in the organization is assigned one or more role, and thereby obtains the permissions assigned to those roles. Role based models of access control simplify the process of limiting access because permissions do not need to be defined and assigned directly to each individual in the organization.

Individuals who work for an organization are often assigned roles based on the organizational structure. For example, a position in the organization, such as a Vice President (“VP”) of Sales, may be assigned a role with permissions to perform actions such as reading, copying, and/or writing to all of the sales department's electronic data. This data may include advertisements, sales reports, customer communications, and similar data. The positions in an organizational structure are often arranged hierarchically, meaning that the responsibilities of a position in the organizational structure include the responsibilities of any positions below it in the organizational structure. Because the positions are arranged hierarchically, the role assignments are also arranged hierarchically, such that a role assignment in the organizational structure includes the permissions of any role assignment below it in the organizational structure. In a typical organizational structure, a second role assignment is below a first role assignment if the individual with the second role assignment is at a position that directly reports to the position of the individual with the first role assignment.

Referring now to FIG. 1A is a diagram illustrating an example of a typical organizational structure. The concepts illustrated in FIG. 1A apply generally to many organizations, even though any particular organization may have more or fewer levels, more or fewer positions at each level, and may use different titles for the positions.

As explained above and as illustrated in FIG. 1A, the typical organizational structure is organized as a hierarchy with a top level and several levels below it. As illustrated in FIG. 1A at 101, the position at the top level is responsible for supervising, either directly or indirectly, all lower level employees in the organization. This position is illustrated in FIG. 1A, as President, Pres 101. There is a second level of positions below the top level with positions that directly report to the President, illustrated as Vice Presidents, VP 1 110 and VP 2 112. For example, if the organization illustrated in FIG. 1A were a manufacturing company, VP 1 could be the VP of Manufacturing, the position responsible for the manufacturing activities in the company. VP 2 could be the VP of Sales, the position responsible for the sales activities in the company. As shown in FIG. 1A, below each position at the second level of the organizational structure is a set of positions that report either directly or indirectly to that position. In the example discussed above, all positions in the manufacturing division would be below VP 1, and all positions in the sales division would be below VP 2. There is a third level of positions that report directly to VP 1 and VP 2, that are illustrated as having the title director. As illustrated in FIG. 1A, Dir A 120 and Dir B 122 report to VP 1, and Dir C 124 and Dir D 126 report directly to VP 2. Again, there is a set of positions below each director position that report either directly or indirectly to that position. In the example discussed above, Dir A 120 and the positions reporting to it could be responsible for the manufacturing of a particular product the company sells, and Dir B 122 and the positions reporting to it could be responsible for the manufacturing of another product. Dir C 124 and the positions reporting to it could be responsible for the sales of a particular product and Dir D 126 and the positions reporting to it could be responsible for the sales of another product. Again, under this third director level is a fourth level with positions reporting directly to each director position and having a set of positions that report to it. Positions at this level are illustrated as manager, M i 130-M viii 140. Manager positions in the manufacturing department could be responsible for managing a particular aspect of the product to which they are assigned. Manager positions in the sales department could be responsible for managing the relationship with particular customers who purchase the product to which they are assigned. Under this fourth manager level is a fifth level with positions reporting directly to each manager. The positions in this level are illustrated in FIG. 1 as employees, Emp a 150-Emp 1161. Each employee would have responsibility for a subset of the responsibilities of the manager he or she directly reports to.

As explained above, a role assignment in a typical organizational structure often includes the permissions of any role assignment below it in the organizational structure. All permissions associated with a particular role assignment are referred to herein as the “set of permissions” for that role assignment. Referring now to FIG, 1B is a diagram illustrating the relationship of the sets of permissions for the role assignments in the organizational structure illustrated in FIG. 1A. In FIG. 1B, the set of permissions for the role assignment for a position in the organizational hierarchy is illustrated as a triangle, which is defined by the points at each of its three corners. While FIG. 1B only illustrates the set of permissions for the role assignments for certain positions, the concepts apply to all positions illustrated in FIG. 1A.

The set of permissions for the role assigned to Emp 1 161 is shown by Triangle 184 185 186. Because Emp 1 161 reports directly to M viii 140, in the example above, these permissions allow Emp 1 161 to access a portion of the electronic data relating to the customer relationship that M viii 140 manages. Thus, the set of permissions for the role assigned to M viii 140, illustrated by Triangle 183 185 187, includes the set of permissions for the role assigned to Emp 161, illustrated by Triangle 184 185 186. In the example above, M viii 140′s set of permissions include access to all electronic data needed to manage the customer relationship, such as the customer's data relating to its use of the product, notes from meetings with the customer, and all correspondence to and from the customer.

Because M viii 140 reports directly to Dir D 126 the set of permissions for the role assigned to Dir D 126, illustrated by Triangle 182 185 188, includes the set of permissions illustrated by Triangle 183 185 187. In the example discussed above, in which Dir D 126 is responsible for the sales of a product, this set of permissions includes access to all electronic data relating to the sales for the product.

In the same manner as discussed above, the set of permissions for the role assigned to VP 2 112. Triangle 181 185 189, includes the set of permissions illustrated by Triangle 182 185 188. In the example above, in which VP 2 is the VP of Sales for the organization, this set of permissions includes the electronic data relating to the sales of the organization's products.

Finally, since VP 2 112 reports directly to the Pres 101, the permission for the role assigned to Pres 101, illustrated by Triangle 180 185 190, includes the set of permissions illustrated by Triangle 181 185 189. This set of permissions includes electronic data relating to the organization's activities and is the largest set of permission for any position in the organization.

Unlike the example illustrated in FIGS. 1A and 1B, in some organizations an individual's role assignments, and therefore the electronic data he or she needs to access, are not based on the individual position in the organizational structure. Instead, individuals in such organizations sequentially work across various projects with varying roles that are independent of the organizational structure. The individuals in such organizations need access to the electronic data associated with each of their varying roles on each of their projects. As explained above, role based models provide an efficient way to control access to the electronic data in an organization, but traditionally have been constrained by an organization's hierarchy. While having greater data access the higher one is in an organizational hierarchy is reasonable in many instances, it is not in others. It would, therefore, be useful to have systems and methods that provide role based access control in organizations in which the individuals' role assignments are independent of the organizational structure.

### SUMMARY

Systems and methods for controlling access to electronic data are disclosed. The systems and methods receive login information for an individual, authenticate the individual based on the received login information, and grant permissions to the authenticated individual for a portion of an organization's electronic data. The permissions are associated with role assignments for the individual, which are independent of any organizational structure. Permissions may be granted to the individual for more than one role assignment based on the same authenticated login information.

In some embodiments, the role assignments are arranged in a role assignment hierarchy having a top level and one or more levels below the top level. In some such embodiments, the first role assignment is at one level in the hierarchy and the second role assignment is at another level in the hierarchy.

In some embodiments in which the role assignments are arranged in a hierarchy, the permissions for a role assignment include the permissions for any role assignment below it in the hierarchy. In some embodiments in which the role assignments are assigned in a hierarchy, the role assignments are assigned by a second individual having a role assignment that is either at the same level or at a higher level in the hierarchy.

In some embodiments, the roles assignments relate to a particular function to be performed. In some such embodiments, roles are only assigned while the function is to be performed, and therefore, the permissions associated with a role assignment are only granted while the function is to be performed.

In some embodiments, each action the individual performs with respect to a portion of the electronic data is logged. In some such embodiments, the log may include an identification of the individual who performed the action, an identification of the action performed, an identification of the electronic data upon which the action was performed, and the date and time that the action was performed. In some embodiments including such a log, the log may be displayed as a viewable report.

In some embodiments, upon verifying the set of login information for the individual, an indication of each of the individual's role assignments is displayed, such that the individual can access the portion of the organization's electronic data associated with each role assignment through the display.

In some embodiments, a designation that the individual is restricted from accessing a restricted portion of the organization's electronic data is also received. In such embodiments, the individual is denied access to the restricted portion of the electronic data.

Systems and methods are also disclosed that control access upon receiving a request that an individual be given a role assignment, wherein the role assignment is outside the organizational structure. Upon receiving the request, the system determines whether or not the role assignment for the individual is allowed. If the role assignment for the individual is not allowed, the system prevents the role assignment from being given to the individual.

### BRIEF DESCRIPTION OF THE DRAWINGS

FIG. 1A is a diagram illustrating an example of a typical organizational structure,

FIG. 1B is a diagram illustrating the relationship between the sets of permissions for the role assignments in the organizational structure illustrated in FIG. 1A.

FIG. 2A is a diagram illustrating an example of defined sets of permissions for an organization in which role assignments are independent of an organizational structure.

FIG. 2B is a table illustrating an example of role assignments for the law firm example described with reference to FIG. 2A.

FIG. 3 is a diagram illustrating a role assignment hierarchy for the role assignments in an organization in which the role assignments are independent of the organizational structure, and illustrating the relationship between the sets of permission for the role assignments at the different levels.

FIG. 4A is a block diagram illustrating an embodiment of a system for controlling access to electronic data.

FIG. 4B is a flow chart illustrating an embodiment of a method for controlling access to electronic data.

FIG. 5 is an example of a table that may be used to verify login information for an individual.

FIG. 6 is an example of a display, which includes an indication for each individual's role assignments through which the individual can access the portion of the organization's electronic data associated with the role assignment.

FIG. 7 is an example of a display for a report logging the actions of an individual.

FIG. 8 is a flow chart illustrating an embodiment of a method for controlling access to electronic data for an individual.

### DETAILED DESCRIPTION

As explained above, in some organizations an individual's responsibilities, and therefore the electronic data the individual needs to access are not based on their position in the organizational structure. In such organizations, an individual has a variety of role assignments that are independent of the organizational structure. A law firm is one example of such an organization although many other types exist. A law firm typically handles several cases at once often involving different areas of the law, and may be divided into groups for each area of law. Each group handles a certain number of cases at a particular time. The work on each case is often divided into projects, and the projects often further divided into tasks. The attorneys in the law firm work on a variety of cases and may have a different role on each case. For example, a senior associate attorney may be responsible for supervising certain cases, managing projects on other cases, and merely handling certain tasks on still other cases.

Law firms must control access to various types of documents stored as electronic data. For example, for each case the firm is handling, the law firm will provide to the opposing party electronic data from their client relating to the issues in the case, and will also receive documents stored as electronic data from the opposing party. This process is known as electronic document production or “ediscovery.” Examples of the type of electronic data produced in a case include emails between the parties, scanned notes from business meetings relating to issues in the case, medical records, and financial information. Often almost any electronic data relating to an issue in the case is produced. Because the electronic data received for a case often contain the parties' very sensitive business information, the law firm needs to limit access to the electronic data. Additionally, law firms create documents that contain attorney-client privileged information and/or sensitive business information, and also need to limit access to such documents. However, attorneys and other individuals working in the law firm need to have access to these and other types of electronic data to handle the varying responsibilities of their role assignments on cases. Therefore, it would be useful for an organization such as a law firm to be able to use role based access control with role assignments that are independent of the organizational structure.

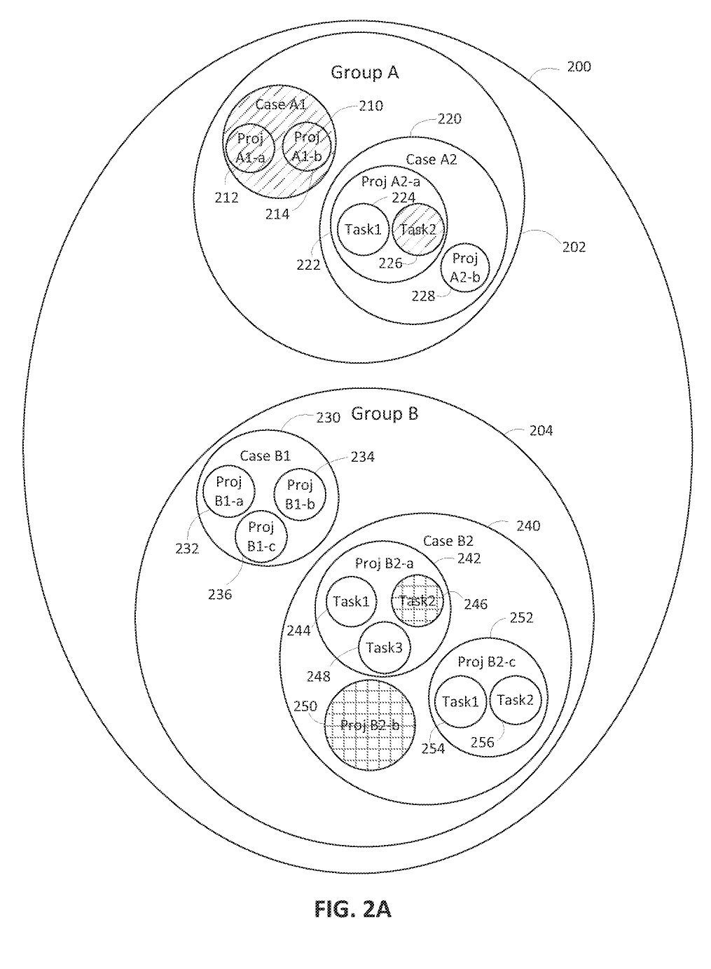

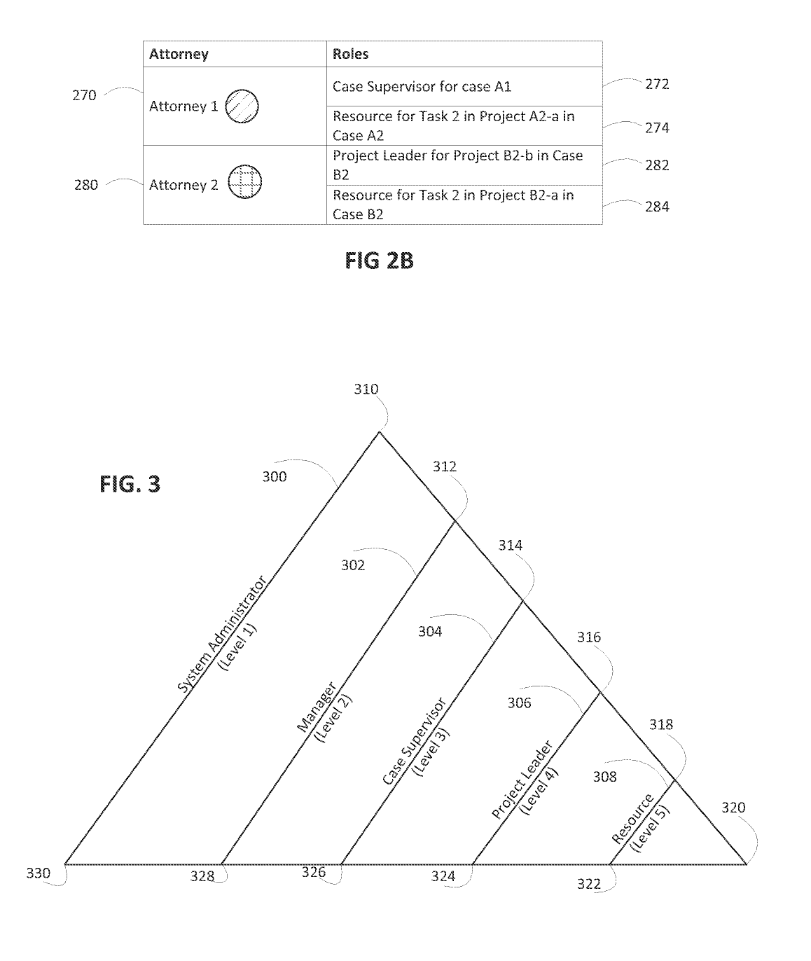

Referring now to FIG. 2A is a diagram illustrating an example of defined sets of permissions for role assignments that are independent of an organizational structure. FIG. 2A illustrates role assignments for a law firm; however, the concepts discussed apply generally to any organization in which role assignments are independent of an organizational structure, and are not limited to law firms nor to the particular structure illustrated in FIG. 2A.

The set of permissions 200 in FIG. 2A is the set of permissions for all of the electronic data in the firm. One role, such as a System Administrator role that is responsible for handling any technical issues relating to the electronic data may be given the set of permissions 200. In the example illustrated in FIG. 2A, the management of the electronic documents may be done in a variety of ways. For example, an outside vendor may manage the servers which store the electronic documents. Alternatively, the firm may have its own servers. Thus, the System Administrator role may be assigned to an employee of either the firm or an outside vendor.

In the example illustrated in FIG. 2A, the law firm is divided into two groups, Group A and Group B. For example, Group A might handle all of the contract cases in the law firm and Group B may handle all of the personal injury cases. The set of permissions for the portion of electronic data associated with the cases in Group A is illustrated at 202. This electronic data may include business documents for the parties, correspondence between the parties, the parties' accounting information, scanned notes from meetings, and a variety of other information relating to a breach of contract case. The set of permissions for the portion of electronic data associated with the cases in Group B is illustrated at 204. This electronic data may include a party's medical records, witness statements about the accident, evidence of a party's income, and a variety of other documents relating to the injury in a personal injury case.

A Manager role may be assigned to manage each of these groups, and therefore be given the set of permissions illustrated at 202 or the set of permissions illustrated at 204. For example, if the data is managed by an outside vendor, there may be a “Customer Manager” role at the outside vendor that is responsible for managing all of the data for a group of cases at the firm, and therefore would need permissions to access all of the data for those cases. Additionally, there may be a role for an attorney at the firm with responsibilities for managing a group, which may also be referred to as a “Group Manager,” and would also need access to all electronic data for that group of cases. As illustrated in FIG. 2A, the sets of permissions for the law firm 200 includes the set of permissions for Group A 202 and the set of permissions for Group B 204. Therefore, the set of permissions for the System Administrator role assignment in the example illustrated in FIG. 2A includes the permissions for all of the Manager roles for the same law firm as the System Administrator.

In the example illustrated in FIG. 2A, there are two cases that Group A is handling. Case A1 with the set of permissions shown at 210, and Case A2 with the set of permissions shown at 220. Group B is also handling two cases, Case B1 with set of permissions 230, and Case B2 with set of permissions 240. To ensure all work on a given case is done, there may be a “Case Supervisor” role assignment for each Case. Because the Case Supervisor would have responsibility for all work on the case, the Case Supervisor would be granted access to all electronic data for the case. For example, the Case Supervisor role assignment for Case A1 would include the set of permissions 210, and similar role assignments and permissions would be true for the Case Supervisor role assignment for each of the other cases. The set of permissions for each group includes the set of permissions for each case in the group. Therefore, the set of permissions for the group manager role assignment in the law firm described with reference to FIG. 2A includes the set of permissions for the all of the Case Supervisor role assignments in the same group.

The work on each of the cases in Group A and Group B has been broken down into projects with a set of permissions for each project. Case A1 has two projects, Proj A1-a with the set of permissions 212, and Proj A1-b with the set of permissions 214. Given that Group A handles contract cases, an example for Proj A1-a could be putting together the evidence showing formation of contract for Case A1. Thus, the set of permissions 212 may include the ability to read and copy the documents relating to communications between the parties, and other documents relating to the contract formation issue. An example for Proj A1-b could be putting together the evidence showing the amount of damages owed for breach of contract in Case A1. Thus, the set of permissions 214 may include the ability to read and copy financial documents in the case, and other documents relating to the damages issue. Case A2 includes two projects, Proj A2-a with set of permissions 222 and Proj A2-b with set of permissions 228. Examples of projects and the associated set of permissions for the projects on Case A2 would be similar to those for Case A1.

Within Group B, Case B1 has three projects, Proj B1-a with the set of permissions 232, Proj B1-b with the set of permissions 234, and Proj B1-c with the set of permissions 236, Case B2 also has three projects, Proj B2-a with the set of permissions 242, Proj 132-b with the set of permissions 250, and Proj 132-c with the set of permissions 252. Given that Group B handles personal injury cases, examples of the three projects for each of the two cases in Group B include putting together the evidence that the defendant was at fault, putting together the evidence to show the extent of the injuries, and putting together the evidence to show the amount of damages due to the injury. Thus, each of the sets of permissions 232, 234, 236, 242, 250, and 252 would include permissions to read and copy documents relating to the issues for each of those projects.

To ensure all work on each project is done, a “Project Leader” role may be assigned for each project and would be granted access to the electronic data for the project. For example, the Project Leader role for Project A1-a would be responsible for putting together the evidence relating to the contract formation issue for Case A1, and would therefore be granted the set of permissions 212, which would include the ability to read and copy the documents relating to communications between the parties, and other documents relating to the contract formation issue. The set of permissions for a case includes the set of permissions for each project in the case. Therefore, a Case Supervisor role assignment in the law firm described with reference to FIG. 2A would include the permissions for all of the Project Leaders role assignments in that case.

Project A2-a in Case A2 has been further broken down into Task 1 with the set of permissions 224 and Task 2 with the set of permissions 226. If Project A2-a is putting together the evidence to show contract formation. Task 1 may include organizing the communications between the parties, and therefore the set of permissions 224 would include the right to read and copy electronic data involving communications between the parties, such as emails. Task 2 may include legal research relating to contract formation, and thus the set of permissions 226 may include the ability to read, copy, or write to legal memorandum relating to that issue.

Project Proj B2-a in Case B2 has been further broken down into three tasks, Task 1 with the set of permissions 244, Task 2 with the set of permissions 246, and Task 3 with the set of permissions 248. Proj B2-c has been further broken down into two tasks, Task 1 with the set of permissions 254, and Task 2 with the set of permissions 256. As with the Task 1 and Task 2 of Project A2-a, specific sub issues for each project would be assigned to the tasks and the associated set of permissions would include the right to read and copy documents relating to the sub issues assigned the tasks.

To perform the work on each task within a project, a “Resource” role may be assigned to the task, and be granted access to the electronic data associated with that particular task. The set of permissions for each project includes the set of permissions for each task for the project. Therefore, a Project Leader rote in the taw firm described with reference to FIG. 2A would include the set of permissions for all Resources assigned to tasks for that project.

Thus, while a partner may have a group of associate attorneys under him in the firm's organizational structure, the partner may have access to less electronic data on a particular case than one of the associates under him. For example, if one of the associates is assigned a Case Supervisor role on a particular case and the partner is only assigned a Project Leader role on that case, the associate will have access to more electronic data for the case than the partner. This is in contrast to the prior art approach of granting access to electronic data based on one's role as determined by one's position in an organizational hierarchy.

FIG. 2B is a table illustrating an example of role assignments for individuals working for the law firm example described with reference to FIG. 2A, i.e., role assignments that are independent of the organizational structure. The individuals working in the law firm include anyone performing work on the cases, regardless of whether the particular individual is an actual employee of the firm. For example, the individuals may be independent contractors working for the firm, employees of outside vendors or resources provided by outside vendors or a client of the law firm.

Attorney 1 270 has the role assignment of Case Supervisor (CS) for Case A1 272, and the role of Resource for Task 2 in Project A2-a in Case A2 274. Thus, Attorney 1 270 would be give the set of permissions 210 and the set of permissions 226, as illustrated in FIG. 2A by the slanted lines. Attorney 2 280 has the role assignment of Project Leader for Project B2-b in Case B2 282, and the role assignment of Resource for Task 2 in Project B2-a in Case B2 284. Thus, Attorney 2 would be given the set of permissions 246 and the set of permissions 250 as illustrated in FIG. 2A by the crossed lines.

It is to be understood that although the role assignments associated with the sets of permissions illustrated in FIG. 2A are independent of the organizational structure, the role assignments themselves are still organized in a hierarchy. Reining now to FIG. 3 is a diagram illustrating a hierarchy for the role assignments in an organization in which the role assignments are independent of the organizational structure. FIG. 3 also illustrates the relationship between the sets of permissions for the role assignments at the different levels. While FIG. 3 illustrates the role assignment hierarchy for the taw firm example described with reference to FIG. 2A, the concepts apply generally and are not limited to law firms, nor to the titles given to the roles at the different levels within the hierarchy.

The lowest level in the hierarchy in FIG. 3 is the Resource Level, Level 5 308. The Resource Level has the smallest set of permissions because the Resource role assignments are only associated with a particular task, and therefore, are only granted the set of permissions to access the portion of the organization's data relating to that particular task. The set of permissions for a Resource role assignment is illustrated in FIG. 3 by Triangle 318 320 322.

The level above the Resource Level in the role based hierarchy is the Project Leader Level, Level 4 306. The Project Leader rote assignment is associated with a particular project, and thus is granted access to the set of permissions for data associated with that project, illustrated in FIG. 3 by Triangle 316 320 324. As illustrated in FIG. 3 and explained above, because a project encompasses the tasks it is broken down into, the set of permissions for a particular Project Leader role assignment includes the set of permissions for the Resource role assignments for the tasks on the project associated with the particular Project Leader role assignment.

The next higher level illustrated in FIG. 3 is the Case Supervisor Level, Level 304. Because a case encompasses the projects it is broken down into, the set of permissions for a particular Case Supervisor role assignment, illustrated by Triangle 314 320 326, includes the sets of permissions for the projects in the case associated with the particular Case Supervisor role assignment, which then also includes the set of permissions for each Project Leader role assignment in that case.

The set of permissions for the Manager Level, Level 2 302, illustrated as Triangle 312 320 328, includes the sets of permission for the cases in the group associated with the Manager role assignment. Regardless of whether the Manager role is a “Customer Manager” at an outside vendor or a “Group Manager” in a law firm, the responsibilities of the Manager role with respect to the electronic data encompass the responsibilities of the Case Supervisors' roles with respect to the electronic data in that group. Additionally, the set of permissions for the highest level, the System Administrator Level, Level 1 300, illustrated by Triangle 310 320 330, includes the sets of permissions for the groups in the law firm associated with the System Administrator role assignment. The System Administrator role assignment encompasses responsibilities for all electronic data associated with all other role assignments in the law firm.

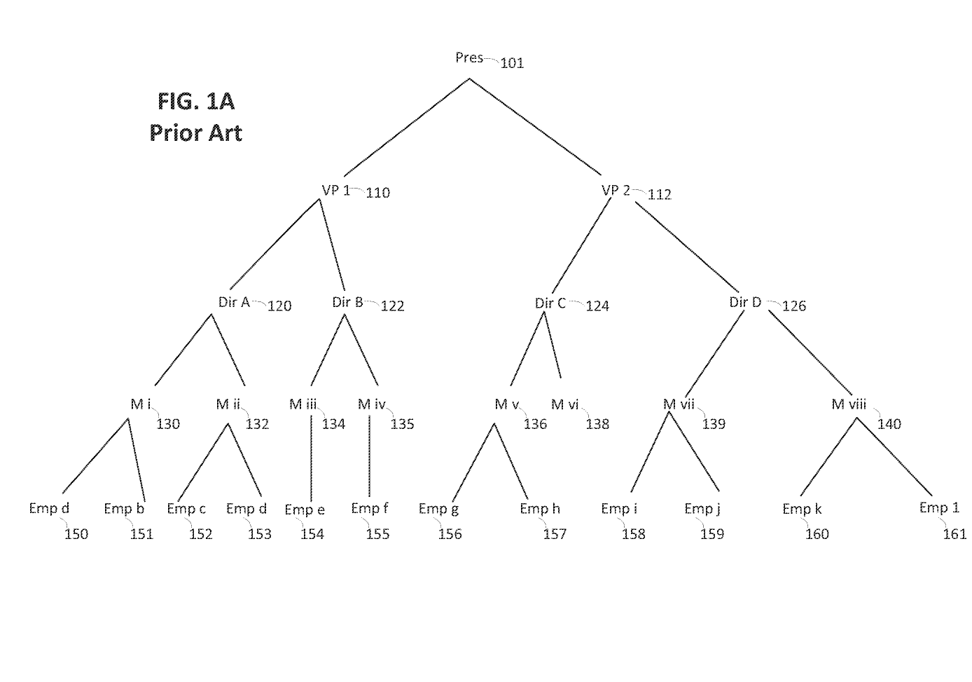

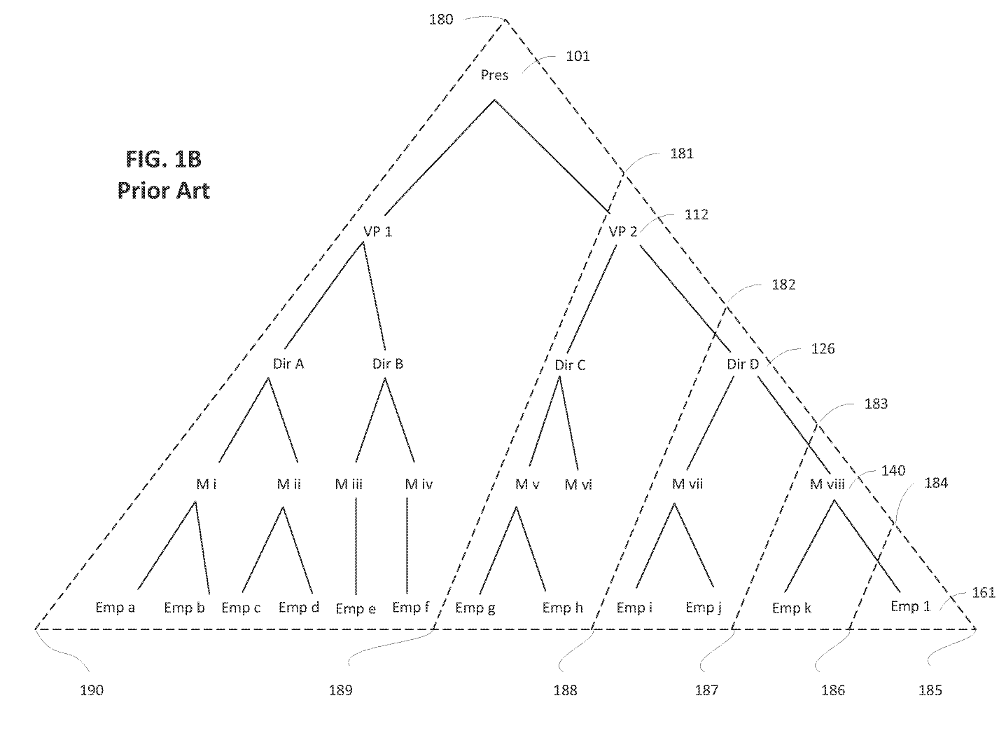

As is illustrated by comparing FIG. 3 to the dotted lines in FIG. 1B, there is a similar relationship between the role assignments at different levels in both hierarchical structures in which the role assignments are based on the organizational structure (as shown in FIG. 1B), and those in which they are independent of the organizational structure (as shown in FIG. 3). What is different, however, is that in an organization in which the role assignments are independent of the organizational structure, an individual with a particular role assignment need not report in an organizational hierarchy directly to an individual with a role assignment directly above them in the role assignment hierarchy. For example, despite an associate attorney being lower on the organizational hierarchy than a partner, the associate may be assigned the Case Supervisor role on a case in which the partner is assigned a Project Leader role. Thus, in an organization in which the role assignments are independent of the organizational structure, a second role assignment is only below a first role assignment if the second role assignment is for an activity relating to the electronic data of the organization that is encompassed by the first role assignment.

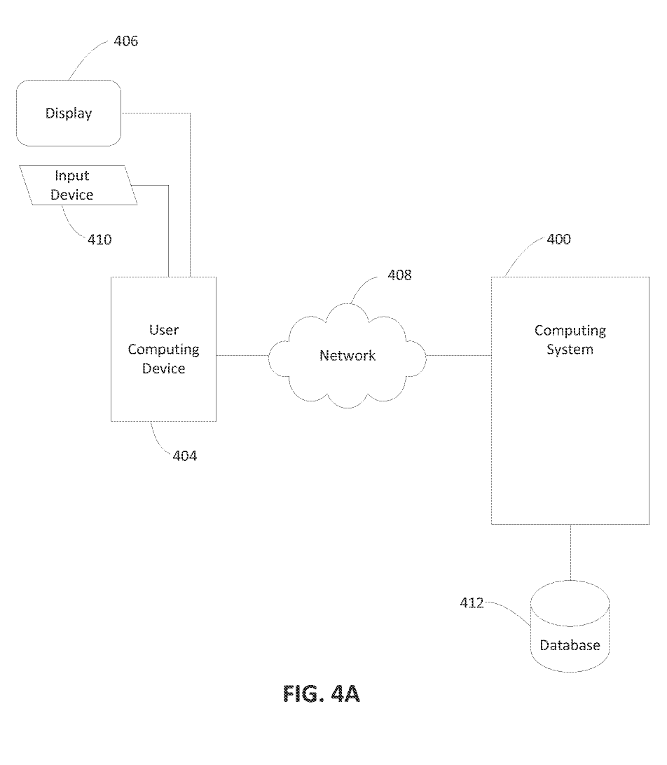

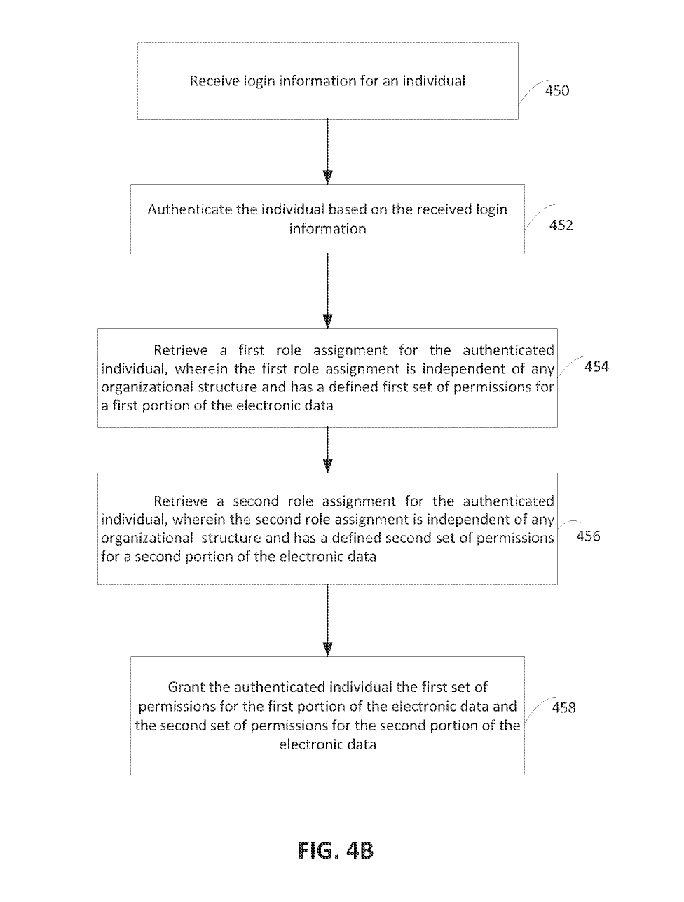

Referring now to FIG. 4A is a block diagram illustrating an embodiment of a system for controlling access to electronic data based on role assignments that are independent of organizational structure. Computing system 400 receives login information and role assignments for an individual and grants sets of permissions for portions of the organization's electronic data based on verifying the individual's login information. Computing system 400 is well understood in the art of computer science, and may include one or more central processing unit(s) and memory. In some embodiments, the computing system 400 is connected either directly or indirectly to a database 412 from which it receives role assignments. Alternatively, the role assignments may be stored in the computing system or may be received from some other source. Computing System 400 is in communication with a user computing device 404, which is connected to a display 406 and an input device 410. As is well understood in the art of computer science, the user computing device may include one or more processors and memory, such as a personal computer, smart phone, or tablet. The display is any device that will allow for displaying electronic data, such as a computer monitor, smart phone screen, or tablet display. As also is well understood in the art, the input device is any device that allows for the entry of electronic data, such as a keyboard, mouse, smart phone touch screen, or tablet touch screen. In some embodiments, the computing system is connected to the user computing device across a network 408, as shown or may be connected directly. As is also well understood in the art of computer science, the network 408 is any communication network, such as a Wide Area Network (“WAN”), a Local Area Network (“LAN”), or the internet.

Referring now to FIG. 4B is a flow chart illustrating an embodiment of a method for controlling access to electronic data based on role assignments that are independent of organizational structure. At step 450, login information for an individual is received at a computing system across a network from a user computing device. In some embodiments, the login information is entered into a user computing device 404 using input device 410, and user computing device 404 communicates the login information across network 408 to computing system 400. Login information is any information used to authenticate an individual. For example, login information may include a user name and/or password.

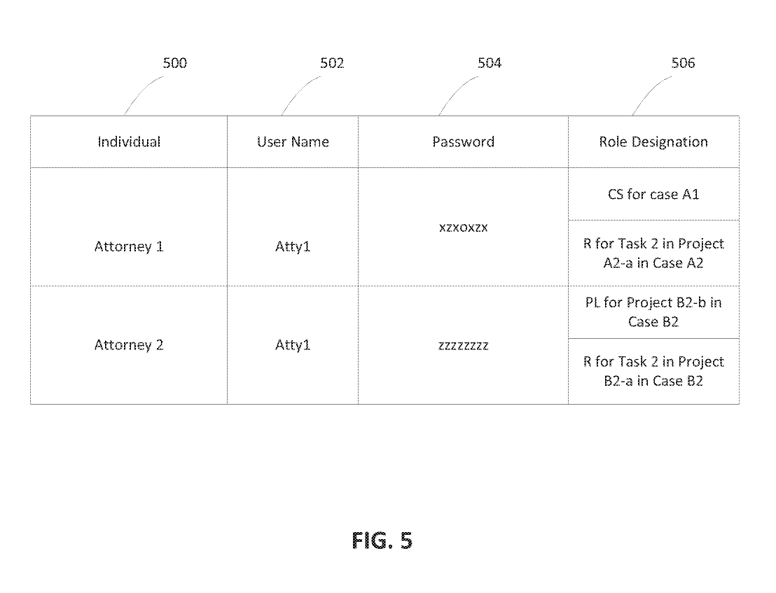

At step 452, the received login information is used to authenticate the individual. As is known in the art of computer science, there are a variety of ways in which the login information may be used to authenticate an individual, the choice of which does not limit the application of the method. Examples include querying a database table containing stored login information for the individuals working with the organization. For example, database 412 of FIG, 4A may have a lookup table (“LUT”) which may be queried to determine if the received login information matches an entry in the table. Referring now to FIG. 5 is an example of a table that may be used to authenticate the individual. Column 500 includes entries for the individuals working for the law firm. In some embodiments, the individuals may not be employees of the firm, but may be independent contractors, or may be provided by a vendor, or by another organization. Column 502 includes the user names for each of the individuals. Column 504 includes the passwords for each individual, and Column 506 includes the roles assignments for each individual. As shown in FIG. 5, more than one role assignment for an individual can be associated with a particular user name and password.

Referring back to FIG. 4B, at step 454 a first role assignment for the individual is retrieved. The first role assignment is independent of any organizational structure. The role assignment may be retrieved by a computing system such as the one illustrated at 400 of FIG. 4A. In some embodiments, the role assignment is stored in a database such as the one illustrated at 412, after having been entered into a user computing device, such as the one illustrated at 404. In some such embodiments, the first role assignment for the individual is retrieved from the database 412 in response to a query from computing system 400 that is initiated after receiving the login information for the individual. The received role assignment has a defined first set of permissions for a first portion of the organization's electronic data. There may be a variety of permissions for the first portion of the electronic data. For example, the permissions may include the ability to read some of the data, the ability to write to some of the data, and the ability to copy some of the data.

In the law firm example described with reference to FIG. 2A and FIG. 2B the first role assignment retrieved is Case Supervisor (CS) for Case A1 272. The defined set of permissions for the role may include access to all the Case A1 documents. As is well understood in the art of computer science, the set of permissions for a role assignment may be defined in a variety of ways, the choice of which does not limit the application of the method. For example, in the law firm example described with reference to FIG. 2A and 2B, when any ediscovery data is received for a particular case, the data may be stored in the database 412 with an indication that the System Administrator role, the Manager role for the group, and the Case Supervisor role for that case have the set of permissions to read the data. Additionally, when any legal document is created in the case, the document may be stored in the database 412 with an indication that the System Administrator role, the Group Manager role for the group, and the Case Supervisor role have the set of permissions to read, write, copy, or edit the document. Additionally, as ediscovery data is reviewed, indications of the permissions for certain units of the data, such as documents, may be stored in database 412. For example, an attorney at the law firm may review ediscovery data at display 406. If a certain document relates to a particular role assignment for the case, the attorney may enter an indication at input device 410 that the role assignment has permissions to read the data. The indication may then be stored in database 412.

Further, the indication of the defined set of permissions for a role may be stored in a variety of ways, so that it may be retrieved by the computing system after the login information for an individual is received and the individual is authenticated. The method illustrated in FIG, 4B is not limited to any particular way that the indication is stored. For example, the permissions may be stored in a database table with an entry for each unit of data, i.e., each document, each role assignment with permissions to access the document, and the actual set of permissions granted to each role assignment. Alternatively, an indication of the set of permissions for each role assignment having access to a particular document may be embedded in the metadata for the document. As is known in the art, the term “metadata” for a document is the information stored about a document other than the actual data comprising the document itself. For example, metadata often includes the date the document was created, the individual entering the document into the system database, etc.

A1 step 456 a second role assignment that is independent of any organizational structure is retrieved. The role assignment has a defined second set of permissions for a second portion of the electronic data of the organization. For example, in the example of the law firm discussed with reference to FIG. 2B, if Attorney 1 270's login information were received and the Attorney authenticated, the second role assignment is that of Resource (R) for Task 2 in Project A2-a in Case A2 274. The explanation above as to how a set of permissions is defined for a first role assignment would apply to the second role assignment as well.

At step 458 the authenticated individual is granted the first set of permissions for the first portion of electronic data and the second set of permissions for the second portion of the electronic data. Referring again to FIG. 5 illustrates a non-limiting example of a table that may be used for granting access for both sets of permission based on using one set of login information to authenticate the individual. As illustrated in column 506, the role assignments for an individual are associated with the same login information for the individual, and therefore, the individual does not need to enter different login information each time access is needed for a particular role assignment. Once the individual has been authenticated with the login information, and the role assignments for an individual have been determined, the defined permissions for those roles may be determined and granted to the individual.

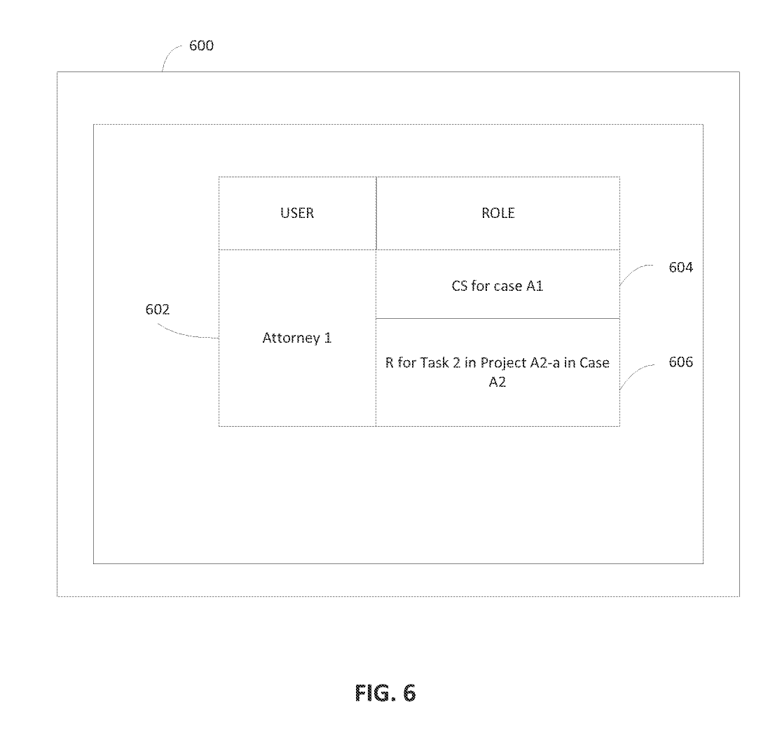

In some embodiments, once the individual is granted access to one or more sets of permissions, the system will display an indication of each of the individual's role assignments, through which the individual can access the portion of electronic data associated with each role assignment. Referring now to FIG. 6 is an example of a screen shot 600 from such an embodiment for Attorney 1 of the example described with reference to FIG. 2B. At 602, the attorney's name is indicated. At 604, an indication of the first role assignment for the individual is displayed. At 606, an indication of the second role assignment for the individual is displayed. The indications may be displayed on a display such as the one shown at 406 of FIG. 4A. As would be well understood in the art of computer science, there are a variety of was an individual can access the electronic data associated with a role through the display, the choice of which does not limit the application of the method. For example, in some embodiments, the user may “click on” the displayed indication using, e.g., input device 410, to be provided access to the electronic data associated with the role assignment.

In some embodiments, the role assignments for an organization may be arranged in a role assignment hierarchy with a top level and one or more levels below the top level, as shown in FIG. 3. In such embodiments, the first and second role assignments can be at different levels in the hierarchy. In some such embodiments, each role assignment below the top level can be below another role assignment in the hierarchy. As explained above in the example of the law firm discussed with reference to FIG. 2A and FIG. 2B, in an organization in which the role assignments are independent of the organizational structure, a second rote assignment is below a first role assignment if the first role assignment encompasses the second role assignment with respect to accessing the organization's electronic data. In some embodiments, the set of permissions for a role assignment includes the sets of permissions for the role assignments below it in the role assignment hierarchy. For example, the set of permissions for the Case Supervisor for Case A1 role 272 of FIG. 2A for Attorney 1 270, includes the sets of permissions for all Project Leaders on Case A1.

In some embodiments, an individual may have a first role assignment that is at a first level in the role assignment hierarchy, and a second role assignment that is at a second level in the role assignment hierarchy. For example as shown in FIG. 2B and FIG. 3, Attorney 1 270 has a Case Supervisor role 272, which is at Level 3 304 of FIG. 3, and a Resource role 274 which is at Level 5 308 of FIG. 3.

In some embodiments, a role assignment may be for a particular function to be performed. For example, the Case Supervisor role, 272 of FIG. 2B, relates to the function of supervising a particular case, the Project Leader role, 282 of FIG. 2B, relates to the function of managing a particular project, and the Resource role, 274 and 284 of FIG. 2B, relates to the function of handling a particular task. In some such embodiments, the role will only be assigned and the associated permissions for the role assignment will only be granted while for the time period in which the function is to be performed. For example, Attorney 1 270 will not be granted the set of permissions for the Task 2 in Proj A2-a in Case A2 274 when it is decided or determined that the task is finished. This may be accomplished in a variety of ways, the choice of which does not limit the method. For example, in embodiments described above in which there is a database table with an entry for each role assignment with permissions to access a document in the table, the role assignment for a particular function may be deleted from the table when the function is no longer to be performed (either because the task has been finished or is no longer needed to be done).

In some embodiments, an individual with a role assignment for an function may assign a role for that function at the same or at a lower level in the role assignment hierarchy. For example, Attorney 1 270 of FIG, 2B can assign the Case Supervisor role for Case A1, the Project Leader roles for Case A1 and the Resource roles for Case A1.

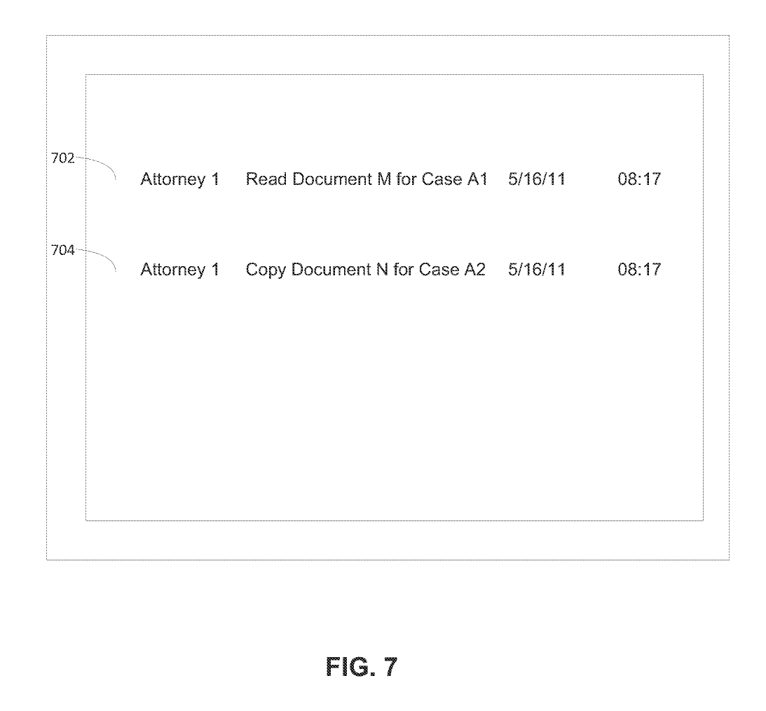

In some embodiments, a log is created for each action the individual performs with respect to the electronic data. In some such embodiments, the log includes an identification of the individual who performed the action, an indication of the action performed, an identification of the electronic data upon which the action was performed, and the date and time that the action was performed. In some embodiments, the log is displayed as a viewable report, for example, on display 406 of FIG. 4A. Referring now to FIG. 7 at 702, and 704 is an example of such a display for Attorney 270 in FIG. 2B.

In some embodiments, a designation is received at the computing system that an individual is restricted from accessing a certain portion of the electronic data. For example, in a law firm, attorneys working on certain projects may be restricted from seeing particular portions of electronic data on a specific case due to, for example, conflict reasons. In some embodiments, the designation may be received at computing system 400, in response to a query to database 412. Once the designation is received the attorney is denied access to the restricted portions of electronic data.

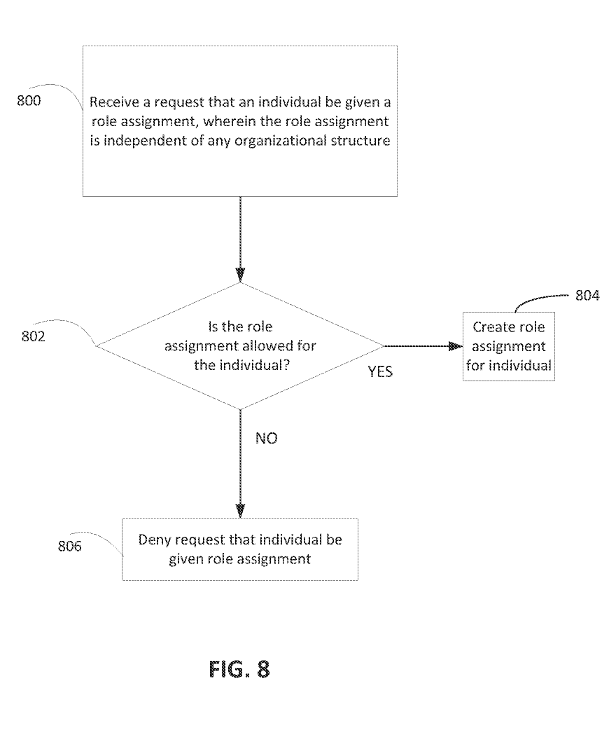

FIG. 8 is a flow chart illustrating an embodiment of a method for controlling access to electronic data for an individual. At 800, a request is received for a role assignment for an individual, wherein the role assignment is independent of any organizational structure. In some embodiments, the request for the role assignment is entered by an individual using an input device 410, and sent by user computing device 404 to computing system 400 across network 408. At 802, the computing system determines whether or not the role assignment is allowed for the individual.

As would be well understood in the art of computer science, there are a variety of ways to determine if the role assignment for the individual is allowed, the choice of which does not limit the application of the method. For example, in some embodiments the designation may be stored in a table in database 412 with an entry for each individual with restricted access and an indication of the role assignments for the individual that are not allowed. When an attempt is made to assign a particular role to an individual, the computing system 400 may query the database 412 to determine if the role assignment is allowed. For example, in a law firm, attorneys who have worked for other organizations may be restricted from working on particular cases or seeing particular electronic data due to a perceived conflict. If there is a response that the role assignment is allowed, computing system 400 will create the role assignment at 804. If there is a response that the assignment is not allowed, the request for the role assignment will be denied at 806.

Although a detailed description of one or more embodiments of the invention has been provided along with accompanying figures that illustrate the principles of the invention, it will be apparent that certain changes and modifications may be practiced within the scope of the appended claims. The invention has been described in connection with such embodiments, but the invention is not limited to any embodiment. The scope of the invention is limited only by the claims and the invention encompasses numerous alternatives, modifications and equivalents. Numerous specific details have been set forth in the description in order to provide a thorough understanding of the invention. These details have been provided for the purpose of example and the invention may be practiced according to the claims without some or all of these specific details. For the purpose of clarity, technical material that is known in the technical fields related to the invention has not been described in detail so that the invention is not unnecessarily obscured.

It should be noted that there are many alternative ways of implementing both the systems and methods of the present invention. For example, the invention can be implemented in numerous ways, including as a process, an apparatus, a system, a composition of matter, a computer readable medium such as a computer readable storage medium. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

What is claimed is:

1. A method for controlling access to electronic data comprising:
receiving at a computing system login information for an individual across a network from a user computing device;
authenticating the individual based on the received login information;
retrieving at the computing system a first role assignment for the authenticated individual, wherein the first role assignment is independent of any organizational structure and has a defined first set of permissions for a first portion of the electronic data;
retrieving at the computer system a second role assignment for the authenticated individual, wherein the second role assignment is independent of any organizational structure and has a defined second set of permissions for a second portion of the electronic data;
granting the authenticated individual the first set of permissions for the first portion of electronic data and the second set of permissions for the second portion of the electronic data.

2. The method of claim 1 wherein the first set of permissions or the second set of permissions includes one of the following: read, write or copy.

3. The method of claim 1 wherein the first role assignment and the second role assignment are in a hierarchy of role assignments, the hierarchy including a top level and one or more levels below the top level.

4. The method of claim 3 wherein the first role assignment is at a first level in the hierarchy of role assignments and the second role assignment is at a second level in the hierarchy of role assignments.

5. The method of claim 3 wherein the first set of permissions includes all of the permissions for any role below the first role assignment in the hierarchy of role assignments.

6. The method of claim 3 wherein the first role assignment was assigned by a second individual having a third role assignment that is either at the same level or at a higher level of role assignments in the hierarchy of role assignments than the first role assignment.

7. The method of claim 1 wherein the first role assignment relates to a particular function to be performed.

8. The method of claim 1 wherein the step of granting the authenticated individual the first set of permissions for the first portion of the electronic data occurs only while the function is to be performed.

9. The method of claim 1 further comprising creating a log of each action the individual performs with respect to the electronic data.

10. The method of claim 1 wherein the log may be displayed as a viewable report.

11. The method of claim 1 wherein the log includes an identification of the individual who performed each action, an identification of each action performed, an identification of the electronic data upon which each action was performed, and when the action was performed.

12. The method of claim 1 further comprising, after authenticating the individual, displaying an indication of each of the roles to which the individual has been assigned and providing the individual with access to the portion of electronic data associated with a role through the displayed indication,

13. The method of claim 1 further comprising:
receiving at the computing system a designation that the authenticated individual is restricted from accessing a restricted portion of the organization's electronic data; and
denying the authenticated individual access to the restricted portion of the electronic data.

14. A method for controlling access to electronic data comprising:
receiving at a computing system across a network from a user computing device a request for that an individual be given a role assignment, wherein the role assignment is independent of any organizational structure;
determining whether the role assignment is allowed for the individual;
denying the request that the individual be given the role assignment in the event that it is determined that the role assignment is not allowed for the individual.

15. A non-transitory computer readable medium containing programming code executable by a processor, the programming code configured to perform a method comprising:
receiving at a computing system login information for an individual across a network from a user computing device;
authenticating the individual based on the received login information;
retrieving at the computing system a first role assignment for the authenticated individual wherein the first role assignment is independent of any organizational structure and has a defined first set of permissions for a first portion of the electronic data;
retrieving at the computer system a second role assignment for the authenticated individual, wherein the second role assignment is independent of any organizational structure and has a defined second set of permissions for a second portion of the electronic data;
granting the authenticated individual the first set of permissions for the first portion of electronic data and the second set of permissions for the second portion of the electronic data.
